(19) United States
(12) Patent Application Publication
(10) Pub. No.: US 2026/0288871 A1
(43) Pub. Date: Sep. 24, 2026

(54) QUESTION ANSWERING METHOD AND QUESTION ANSWERING SYSTEM

(71) Applicant: Industrial Technology Research Institute, Hsinchu (TW)

(72) Inventors: Jia-Jang Tu, Hsinchu City (TW); Ching-Hsien Lee, Tainan City (TW)

(73) Assignee: Industrial Technology Research Institute, Hsinchu (TW)

(21) Appl. No.: 19/224,926

(22) Filed: Jun. 2, 2025

(30) Foreign Application Priority Data
Mar. 18, 2025 (TW) 114110131

(51) Int. Cl. G06F 16/9032; G06F 16/23

(52) U.S. Cl. CPC G06F 16/90332; G06F 16/23

(57) ABSTRACT

This disclosure proposes a method and a system for question answering. The method includes: obtaining a question from a user; executing a matching algorithm based on the question to determine whether the question matches one of multiple predefined questions in a frequently asked database; if the question matches a first predefined question, outputting a first predefined answer corresponding to the first predefined question; if the question does not match any predefined question, inputting the question into a language model to generate a response; outputting the generated response; and updating the frequently asked database based on the generated response.

### CROSS-REFERENCE TO RELATED APPLICATION

This application claims the priority benefit of Taiwan application serial no. 114110131, filed on Mar. 18, 2025. The entirety of the above-mentioned patent application is hereby incorporated by reference herein and made a part of this specification.

### TECHNICAL FIELD

This disclosure is related to a question answering method and system combining discriminative artificial intelligence and generative artificial intelligence.

### BACKGROUND

With the rapid development of Generative Artificial intelligent (AI) technology, especially Large Language Model (LLM), customer service systems are gradually applying these technologies to enhance the ability to solve user questions. However, existing generative approaches usually require substantial computational resources and operational costs, particularly in scenarios using paid LLMs. For high-frequency query scenarios (such as intelligent customer service systems), this may lead to unnecessary waste of computational resources and increase operational costs.

Traditional customer service systems mainly rely on rule-based retrieval technology or discriminative AI. These methods have lower computational costs and can quickly provide predefined answers, suitable for structured and predictable question scenarios. However, when users ask questions not covered in the database, the response ability of such systems is limited, unable to provide sufficient flexibility to handle varied or unseen questions.

Therefore, the main challenge of existing technology is how to effectively combine Discriminative AI with generative LLM in customer service systems, thereby balancing response accuracy, flexibility, and computational cost.

### SUMMARY

To solve the above problems, this disclosure proposes a question answering method and a question answering system, which may accelerate the speed of answering and continuously update the database.

This disclosure proposes a question answering method, applicable to computer systems. This question answering method includes: getting a first question from a user; executing a matching algorithm according to the first question to determine whether the first question matches one of multiple default questions in a frequently asked database; if the first question matches a first default question, outputting a first default answer corresponding to the first default question; if the first question does not match any default question, inputting the first question to a language model to obtain a first generated answer; outputting the first generated answer; and updating the frequently asked database according to the first generated answer.

From another perspective, the implementation of this disclosure proposes a question answering system, including a memory and a processor, both electrically connected to each other. The processor executes instructions in the memory to perform the question answering method described above.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram illustrating a question answering system according to an implementation.

FIG. 2 is a schematic diagram illustrating the operation of a question answering system according to an implementation.

FIG. 3 is a flowchart illustrating the process of updating a frequently asked database according to an implementation.

FIG. 4 is a schematic diagram illustrating a conversation record according to an implementation.

### DETAILED DESCRIPTION OF DISCLOSURED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Regarding the terms “first,” “second,” etc. used in this document, they do not specifically indicate sequence or order, but are merely used to distinguish components or operations described using the same technical terminology.

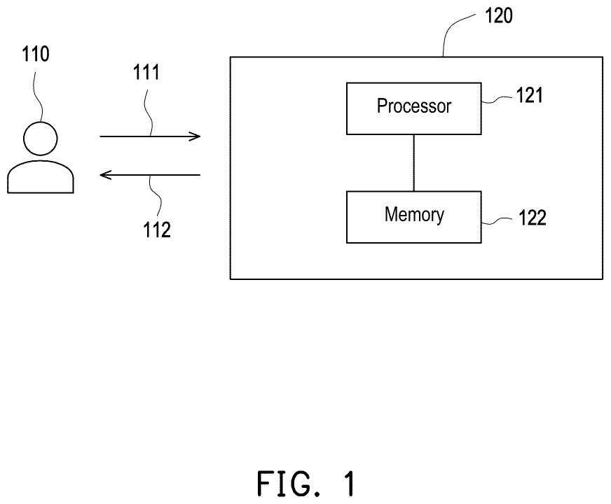

FIG. 1 is a schematic diagram illustrating a question answering system according to an implementation. Referring to FIG. 1, a question answering system 120 may be implemented as a mobile phone, personal computer, tablet computer, server, wearable device, home appliance, or any electronic device with computing ability. The question answering system 120 includes a processor 121 and a memory 122, which are electrically connected to each other. The processor 121 may include a central processing unit, microprocessor, microcontroller, deep-learning processing unit (DPU), neural network processing unit (NPU), tensor processing unit (TPU), Application Specific Integrated Circuits (ASIC), Programmable Logic Device (PLD), etc. The memory 122 may include random access memory, read-only memory or flash memory, in which multiple instructions are stored. The processor 121 executes the instructions in the memory 122 to perform a question answering method.

The user 110 may input a question 111 through any suitable interface device, such as a microphone, keyboard, touch screen, mouse, etc. After the processor 121 perform the question answering method, it will generate an answer 112, which is then provided to the user 110 through appropriate interface devices, such as a screen, speaker, etc. In some implementations, the question answering system 120 may be a chatbot, artificial intelligence agent, customer service system, etc., but this disclosure is not limited thereto.

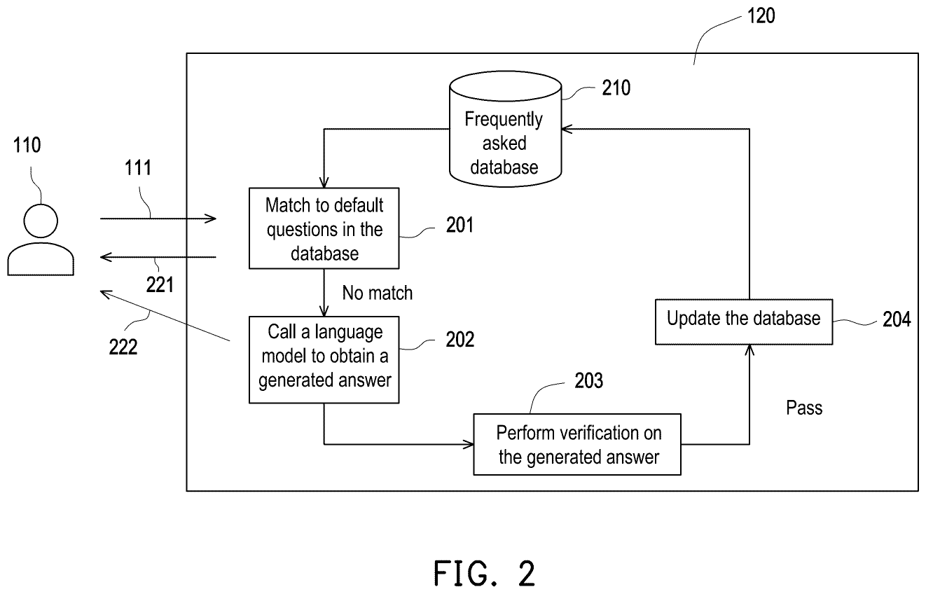

FIG. 2 is a schematic diagram illustrating the operation of a question answering system according to an implementation. Referring to FIG. 2, first the question answering system 120 gets the question 111 from the user. In step 201, a matching algorithm is executed according to this question 111 to determine whether this question matches one of multiple default questions in a frequently asked database 210. For example, these default questions are about financial services, may include “what is the fee”, “what to do if I forget my password”, “what to do if I lose my credit card”, etc., and each default question corresponds to a default answer. In some implementations, multiple default questions may also correspond to the same default answer, for example, “I want to report a lost credit card” and “what to do if I lose my credit card” will correspond to the same default answer.

The above matching algorithm may adopt any rule-based algorithm or machine learning algorithm. For example, the machine learning algorithm may include a neural network, where the question 111 would be converted into multiple tokens, each token is a vector, and these tokens are input to the neural network. There are at least two approaches to design the neural network. In the first approach, the output of the neural network is multiple confidence values, these confidence values correspond to the default questions respectively, representing the similarity between the corresponding default question and question 111. In the second approach, the output of the neural network is a feature vector, and each default question is also inputted to the neural network to obtain the corresponding feature vector, where a similarity between two feature vectors are calculated to obtain a confidence value. The similarity may be cosine similarity or Euclidean distance (inversely proportional to the confidence value). These approaches using the neural network can also be called discriminative AI. Regardless of which approach above is adopted, the confidence value between the question 111 and each default question is calculated. Next, a maximum of these confidence values are calculated, and it is determined whether this maximum value is greater than a confidence threshold. If the maximum value is greater than the confidence threshold, it is determined that question 111 matches the default question corresponding to the maximum value; if the maximum value is less than or equal to the confidence threshold, it is determined that the question 111 does not match any default question.

When the question 111 matches a certain default question (also referred to as a first default question), the default answer (also referred to as a first default answer) corresponding to the first default question is obtained from the frequently asked database 210, and this first default answer 221 is output to the user 110.

When the question 111 does not match any default question, at step 202, a language model is called, and the question 111 is input to this language model to obtain a generated answer (also referred to as a first generated answer), and then the first generated answer 222 is output to the user 110. This language model may be from the GPT (Generative Pretrained Transformer) series, BERT (Bidirectional Encoder Representations from Transformers) series, LLaMA (Large Language Model Meta AI) series, etc., but the present disclosure is not limited thereto. This language model may be locally deployed in the question answering system 120, or it may be deployed in the cloud where the question answering system 120 uses an application interface (API) to call the language model. Next, at step 203, verification can be performed on the first generated answer, this verification may include correctness verification, reliability verification, accuracy verification, etc., but the present disclosure is not limited thereto. In some implementations, the question 111 and the first generated answer 222 may be input together to the language model, and through appropriate prompts, the language model determines whether such question and answer are correct, reliable, or accurate. The language models used in the step 202 and step 203 may be the same or different. After passing the verification, at step 204, the frequently asked database 210 is updated according to the first generated answer 222 by, for example, adding a match formed by the question 111 and the first generated answer 222, modifying a certain default answer in the frequently asked database 210, making the question 111 correspond to an existing default answer, merging the question 111 with an existing default question, merging the first generated answer 222 with an existing default answer, and so on. If it does not pass the verification, the frequently asked database 210 will not be updated.

In some implementations, the language model generates the first generated answer 222 according to a retrieval augmented generation (RAG) algorithm. In other words, the language model may query various databases or web pages based on the question 111, and combine or summarize the obtained results to obtain the first generated answer 222.

In some implementations, the question answering system 120 executes the step of updating the frequently asked database 210 in a non-real-time state. The purpose of this is to provide answers to the user 110 in real-time, and then perform the update after the connection between the user 110 and the question answering system 120 is disconnected, or when the question answering system 120 has idle resources.

In the above approach, the matching algorithm is used first to try to find matching default questions and default answers from the frequently asked database 210, and only calls the language model when there is no match. This approach can avoid frequent calls to the language model, which can reduce computational resources or API usage fees. In addition, the generated answers can also be used to update the frequently asked database 210, so when similar questions are encountered in the next time, there is a higher probability of successful matching. That is, as the system operates, the frequency of using the frequently asked database 210 will increase, and the language model is only called when receiving questions that have not appeared before. This not only reduces cost but also increases the speed of answering.

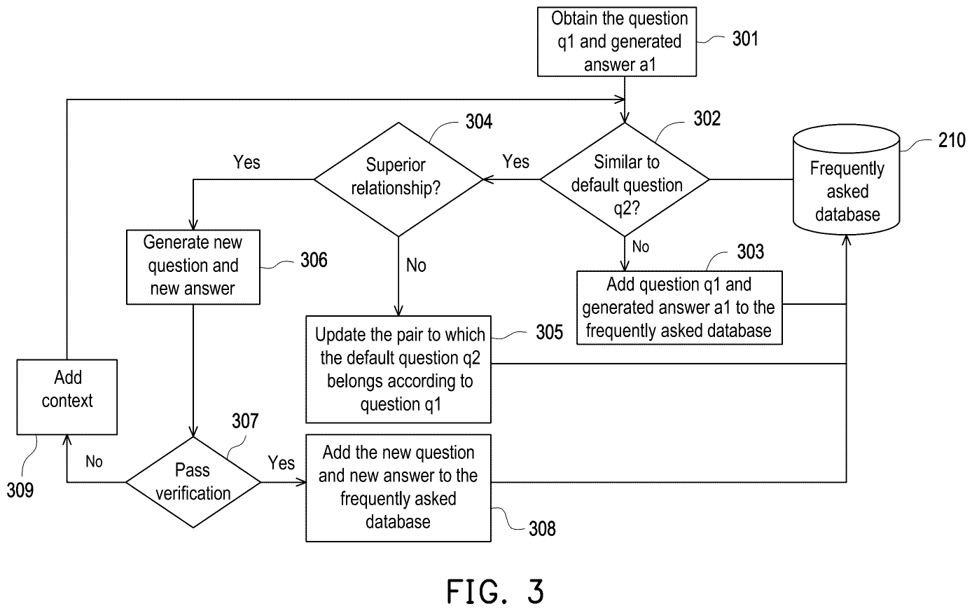

FIG. 3 is a flowchart illustrating the process of updating the frequently asked database according to an implementation. Referring to FIG. 3, first at step 301, the question 111 (hereinafter referred to as q1) and the first generated answer 222 (hereinafter referred to as a1) mentioned above are obtained.

At step 302, all default questions, question q1, and appropriate prompts are input to the language model to determine whether the question q1 is similar to one of the default questions. Step 302 is different from the matching algorithm mentioned above; this step utilizes the language model's superior understanding ability to determine whether there are similar default questions. If there is no similar default question in the frequently asked database 210, at step 303, the question q1 and generated answer al are combined into a pair (q1, a1) and added to the frequently asked database 210.

In some implementations, before adding the pair (q1, a1) to the frequently asked database 210, it may first be determined whether this pair (q1, a1) passes verification. As mentioned above, this verification may include one or more of correctness verification, reliability verification, and accuracy verification, which is also executed by the language model. Only after the pair (q1, a1) passes verification will the pair (q1, a1) be added to the frequently asked database 210. If the pair (q1, a1) does not pass verification, it will not be added to the frequently asked database 210.

If the result of step 302 is yes (assuming question q1 is similar to a default question q2), then at step 304, the question q1, default question q2, and appropriate prompts are input to the language model to determine whether the question q1 and default question q2 belong to a superior relationship. This superior relationship refers to one question being more general than another, or both being different sub-questions under the same topic. For example, one question is “Can I bring outside food to this attraction?” and another question is “Can I bring pets into this attraction?”, since both questions are about the relevant regulations of the attraction, they belong to a superior relationship. In some implementations, the prompt used may be “Are these two questions in a superior relationship or can they be merged?” If the determination result of step 304 is no, at step 305, the pair (q2, a2) to which the default question q2 belongs is updated according to question q1, where a2 is the default answer corresponding to default question q2. For example, the default answer a2 may be used to replace the generated answer a1, making question q1 also correspond to the default answer a2. In this way, both question q1 and default question q2 will correspond to default answer a2. When a user asks other questions similar to question q1 next time, there is an opportunity to directly use the default answer a2 to reply to the user.

If the result of step 304 is yes, at step 306, the question q1, default question q2, and appropriate prompts are input to the language model to generate a new question q_new. Additionally, the generated answer a1, default answer a2, and appropriate prompts are input to the language model to generate a new answer a_new. Here, the prompt used may be “Please merge these two questions (answers) according to their meaning.” For example, two questions are “Can I bring outside food to this attraction?” and “Can I bring pets into this attraction?”, and the merged new question is “Can I bring outside food or pets to this attraction?” Next, at step 307, the language model determines whether the new question q_new and new answer a_new pass verification. If they pass verification, at step 308, the new question q_new and new answer a_new form a pair (q_new, a_new) to be added to the frequently asked database 210, and this pair (q_new, a_new) is used to replace the original default question q2 and default answer a2. In this scenario, as users ask related or superior relationship questions, the question answering system 120 may continuously update the frequently asked database 210, merging new information into the original default questions and default answers.

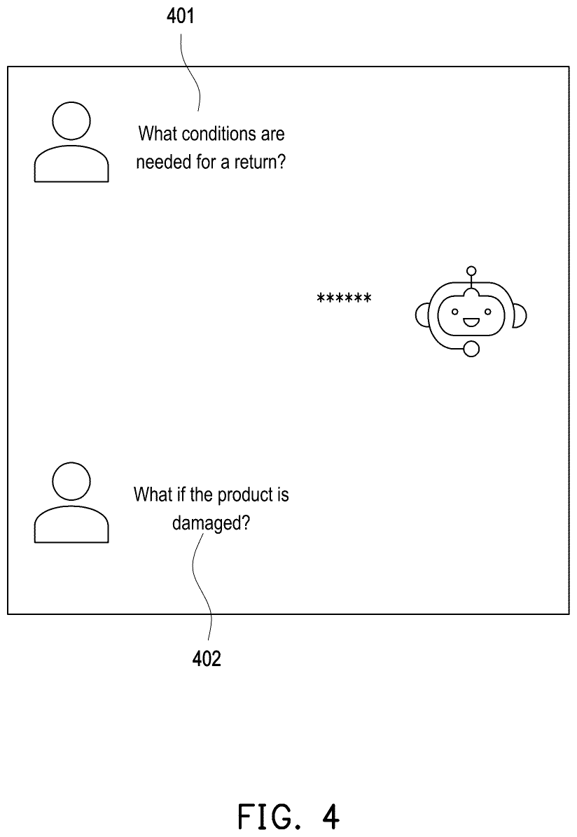

If the result of step 307 is no, at step 309, the context of question q1 is obtained, and the question q1 and the context are combined to generate a new question q3. For example, FIG. 4 is a schematic diagram illustrating dialogue records according to an implementation. Dialogue 401 contains “What conditions are needed for a return?” and dialogue 402 contains “What if the product is damaged?” When dialogue 402 is provided as a question to the question answering system 120, it is not possible to find a suitable default question based solely on the content of the dialogue 402, and even if a similar default question is found, it cannot pass verification (the result of step 307 is no). Therefore, the dialogue 401 may be obtained as the context for the dialogue 402. In some implementations, the dialogues 401 and 402 are inputted to the language model, and the language model will output the merged question q3. For example, the merged question q3 may be “What conditions are needed for a return if the product is damaged?” Next, the question is input to the language model to obtain a generated answer a3.

Next, returning to step 302, the question q1 described above is replaced with the question q3, the generated answer al is replaced with the generated answer a3, and the steps 302-307 are repeated until passing verification at step 307. If the verification still fails when executing the step 307 for the second time, at step 309, dialogues from further back in time may be obtained as context. In some implementations, if there are no previous dialogues available as context, then at step 306, the randomness of the language model may be relied upon to generate different questions and answers. In some implementations, a maximum repetition limit may be set, and when the number of failed verifications reaches this maximum repetition limit, the process is terminated, meaning that the latest question and answer will not be updated to the frequently asked database 210.

Through the process of FIG. 3, the frequently asked database 210 are updated in different approaches. The step 303 adds a new match, the step 305 adds a new question corresponding to an existing answer, and the step 308 combines the new question (answer) with the original question (answer). After updating, the matches stored in the frequently asked database 210 can cover more questions and can also add information to the original answers. In some experiments, such updates can make the process of FIG. 2 faster, and because the default questions in the database 210 will be updated, the accuracy can also be improved.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A question answering method performed by a computer system, the question answering method comprising:
getting a first question from a user;
executing a matching algorithm according to the first question to determine whether the first question matches to one of a plurality of default questions in a frequently asked database;
when the first question matches to a first default question of the default questions, outputting a first default answer corresponding to the first default question;
when the first question does not match to the default questions, inputting the first question to a language model to obtain a first generated answer;
outputting the first generated answer; and
updating the frequently asked database according to the first generated answer, wherein the step of updating the frequently asked database according to the first generated answer comprises:
(a) inputting the default questions, the first question and a prompt to the language model to obtain a result;
(b) when the result is no, combining the first question and the first generated answer into a first match to add to the frequently asked database;
(c) when the result is yes, inputting the first question and the second default question to the language model to determine whether the first question and the second default question belong to a superior relationship;
(d) when the first question and the second default question do not belong to the superior relationship, updating a match to which the second default question belongs according to the first question;
(e) when the first question and the second default question belong to the superior relationship, inputting the first question and the second default question to the language model to generate a first new question, inputting the first generated answer and a second default answer corresponding to the second default question to the language model to generate a first new answer;
(f) determining by the language model whether the first new question and the first new answer pass a verification; and
(g) when the first new question and the first new answer pass the verification, combining the first new question and the first new answer into a second match to add to the frequently asked database, and replacing the second default question and the second default answer with the second match.

2. The question answering method as claimed in claim 1, wherein the step of executing the matching algorithm according to the first question to determine whether the first question matches to one of the plurality of default questions in the frequently asked database comprises:
calculating a confidence value between the first question and each of the default questions;
calculating a maximum value of the confidence values;
determining whether the maximum value is greater than a confidence threshold;
when the maximum value is greater than the confidence threshold, determining that the first question matches to the default question corresponding to the maximum value; and
when the maximum value is less than or equal to the confidence threshold, determining that the first question does not match to the default questions.

3. (canceled)

4. The question answering method as claimed in claim 1, wherein before adding the first match to the frequently asked database, the question answering method further comprising:
determining by the language model whether the first question and the first generated answer pass a verification;
when the first question and the first generated answer pass the verification, adding the first match to the frequently asked database; and
when the first question and the first generated answer do not pass the verification, not adding the first match to the frequently asked database.

5-6. (canceled)

7. The question answering method as claimed in claim 1, further comprising:
(h) when the first new question and the first new answer do not pass the verification, getting a context corresponding to the first question, combining the first question and the context to generate a second question; and
(i) inputting the second question to the language model to obtain a second generated answer.

8. The question answering method as claimed in claim 7, further comprising:
replacing the first new question with the second new question, replacing the first new answer with the second new answer, to repeat the steps (a) to (i).

9. The question answering method as claimed in claim 1, wherein the language model generates the first generated answer according to a retrieval augmented generation algorithm.

10. The question answering method as claimed in claim 1, wherein the step of updating the frequently asked database according to the first generated answer is executed in a non-real-time state.

11. A question answering system, comprising:
a memory, storing a plurality of instructions; and
a processor, electrically connected to the memory and configured to execute the instructions to perform a plurality of steps:
getting a first question from a user;
according to the first question, executing a matching algorithm to determine whether the first question matches to one of a plurality of default questions in a frequently asked database;
when the first question matches to a first default question of the default questions, outputting a first default answer corresponding to the first default question;
when the first question does not match to the default questions, inputting the first question to a language model to obtain a first generated answer;
outputting the first generated answer; and
updating the frequently asked database according to the first generated answer, wherein the step of updating the frequently asked database according to the first generated answer comprises:
(a) inputting the default questions, the first question and a prompt to the language model to obtain a result;
(b) when the result is no, combining the first question and the first generated answer into a first match to add to the frequently asked database;
(c) when the result is yes, inputting the first question and the second default question to the language model to determine whether the first question and the second default question belong to a superior relationship;
(d) when the first question and the second default question do not belong to the superior relationship, updating a match to which the second default question belongs according to the first question;
(e) when the first question and the second default question belong to the superior relationship, inputting the first question and the second default question to the language model to generate a first new question, inputting the first generated answer and a second default answer corresponding to the second default question to the language model to generate a first new answer;
(f) determining by the language model whether the first new question and the first new answer pass a verification; and
(g) when the first new question and the first new answer pass the verification, combining the first new question and the first new answer into a second match to add to the frequently asked database, and replacing the second default question and the second default answer with the second match.

12. The question answering system as claimed in claim 11, wherein the step of executing the matching algorithm according to the first question to determine whether the first question matches to one of a plurality of default questions in the frequently asked database comprises:
calculating a confidence value between the first question and each of the default questions;
calculating a maximum value of the confidence values;
determining whether the maximum value is greater than a confidence threshold;
when the maximum value is greater than the confidence threshold, determining that the first question matches to the default question corresponding to the maximum value; and
when the maximum value is less than or equal to the confidence threshold, determining that the first question does not match to the default questions.

13. (canceled)

14. The question answering system as claimed in claim 11, wherein before adding the first match to the frequently asked database, the steps further comprising:
determining by the language model whether the first question and the first generated answer pass a verification;
when the first question and the first generated answer pass the verification, adding the first match to the frequently asked database; and
when the first question and the first generated answer do not pass the verification, not adding the first match to the frequently asked database.

15-16. (canceled)

17. The question answering system as claimed in claim 11, wherein the steps further comprising:
(h) when the first new question and the first new answer do not pass the verification, getting a context corresponding to the first question, combining the first question and the context to generate a second question; and
(i) inputting the second question to the language model to obtain a second generated answer.

18. The question answering system as claimed in claim 17, wherein the steps further comprising:
replacing the first new question with the second new question, replacing the first new answer with the second new answer, to repeat the steps (a) to (i).

19. The question answering system as claimed in claim 11, wherein the language model generates the first generated answer according to a retrieval augmented generation algorithm.

20. The question answering system as claimed in claim 11, wherein the step of updating the frequently asked database according to the first generated answer is executed in a non-real-time state.
